(19) United States
(12) Patent Application Publication
(10) Pub. No.: US 2021/0162921 A1
(43) Pub. Date: Jun. 3, 2021

(54) DISPLAY ASSEMBLY, DISPLAYING METHOD THEREOF AND VEHICLE HAVING THE SAME

(71) Applicant: BOE TECHNOLOGY GROUP CO., LTD., Beijing (CN)

(72) Inventor: Changlin Leng, Beijing (CN)

(73) Assignee: BOE TECHNOLOGY GROUP CO., LTD., Beijing (CN)

(21) Appl. No.: 15/777,757

(22) PCT Filed: Nov. 23, 2017
(86) PCT No.: PCT/CN2017/112537

§ 371 Date: May 21, 2018

(30) Foreign Application Priority Data
Mar. 1, 2017 (CN) 201710117210.2

(51) Int. Cl. B60R 1/00; G06T 7/73; H04N 7/18; H04N 5/232

(52) U.S. Cl. CPC B60R 1/00; G06T 7/74; H04N 7/18; H04N 5/23229; G06T 2207/30252; B60R 2300/304; B60R 2300/205; B60R 2300/8053; B60R 2300/10

(57) ABSTRACT

A display assembly, a displaying method thereof and a vehicle having the same are provided. The display assembly includes a vehicle display screen (1) and an image processing apparatus (2). The image processing apparatus (2) is configured to synthesize landscape images of a same route captured at different environmental visibilities, so as to enable the vehicle display screen (1) to display an actual landscape with a higher environmental visibility than a current environment visibility when the vehicle runs on the same route. With the image processing apparatus (2), the vehicle display screen (1) of the display assembly can display the actual landscape with a high environmental visibility at the current low environmental visibility, such that a driver can more clearly understand the actual road conditions and traffic situations along the same route at the current low environmental visibility, thereby ensuring the vehicle to run safely at a low environmental visibility and improving the driving experience.

### CROSS-REFERENCE TO RELATED APPLICATION

This application claims priority to and benefits of Chinese Patent Application Serial No. 201710117210.2, filed with the State Intellectual Property Office of P. R. China on Mar. 1, 2017, the entire content of which is incorporated herein by reference.

### FIELD

The present disclosure relates to the field of display technology, and more particularly to a display assembly, a displaying method thereof and a vehicle having the same.

### BACKGROUND

For safe driving, it is generally necessary for a driver to clearly and real timely understand the front road conditions during driving. However, the sight of the driver becomes poor at a low environmental visibility at night or on a foggy day. For example, the driver cannot clearly see defects on a pavement, exits and entrances upon lane change, turns, and traffic situations, etc., which seriously affects the driving safety.

Thus, it becomes an urgent problem to be solved on how to make the driver understand road conditions clearly at the low environmental visibility.

### SUMMARY

In a first aspect, a display assembly is provided. The display assembly includes: a vehicle display screen disposed at least partially inside a vehicle; and an image processing apparatus in communication with the vehicle display screen. The image processing apparatus is configured to synthesize landscape images of a same route captured at different environmental visibilities. The image processing apparatus is further configured to instruct the vehicle display screen to display an actual landscape with a higher environmental visibility than a current environmental visibility when the vehicle runs on the same route.

In some embodiments, the image processing apparatus comprises: an image library, configured to prestore a first landscape image of a first route captured at a first environmental visibility; a camera disposed at least partially outside of the vehicle, configured to real timely shoot a second landscape image of the first route at a second environmental visibility, where the first environmental visibility is higher than the second environmental visibility; a comparator, configured to compare the first landscape image and the second landscape image, so as to judge whether a real time position of the vehicle coincides with a position where the first landscape image is captured; an image synthesizer, configured to synthesize the first landscape image and the second landscape image into an actual landscape image at the first environmental visibility and to send the actual landscape image to the vehicle display screen when the comparator determines that the real time position of the vehicle coincides with the position where the first landscape image is captured.

In some embodiments, the image processing apparatus further comprises an adjusting circuitry configured to adjust the real time position of the vehicle to the position where the first landscape image is captured when the comparator determines that the real time position of the vehicle does not coincide with the position where the first landscape image is captured.

In some embodiments, the image library is further configured to prestore landscape images of a plurality of second routes captured at the first environmental visibility; the image processing apparatus further comprises a positioning circuitry configured to real timely position the vehicle and a selecting circuitry configured to select the first landscape image from the image library and send the first landscape image to the comparator when the positioning circuitry determines that the vehicle runs on the first route.

In some embodiments, each of the first landscape image and the second landscape image is a landscape picture sequence or a landscape video sequence.

In some embodiments, the image synthesizer is configured to supplement a brightness and colorfulness of the actual landscape image at the first environmental visibility.

In some embodiments, the vehicle display screen is a front windshield of the vehicle; or the vehicle display screen is disposed on a partial or entire surface of the front windshield of the vehicle; or the vehicle display screen is a vehicle projection screen disposed on the front windshield of the vehicle or being the front windshield of the vehicle; or the vehicle display screen is vehicle glasses or disposed on the vehicle glasses.

In some embodiments, the positioning circuitry is disposed at a central position of the vehicle.

In a second aspect, a vehicle includes a display assembly described above.

In a third aspect, a displaying method may be implemented by a display assembly above. The method may include: comparing, adjusting and synthesizing landscape images of a same route captured at different environmental visibilities; displaying, by a vehicle display screen, an actual landscape image with a higher environmental visibility than the current environmental visibility, based on a previously obtained result.

In some embodiments, comparing, adjusting and synthesizing landscape images of the same route captured at different environmental visibilities comprises: prestoring a first landscape image of a first route captured at a first environmental visibility; real timely shooting a second landscape image of the first route at a second environmental visibility, where the first environmental visibility is higher than the second environmental visibility; comparing the first landscape image and the second landscape image, so as to judge whether a real time position of the vehicle coincides with a position where the first landscape image is captured; synthesizing the first landscape image and the second landscape image into the actual landscape image at the first environmental visibility and sending the actual landscape image to the vehicle display screen, when the real time position of the vehicle coincides with the position where the first landscape image is captured; and adjusting the real time position of the vehicle to the position where the first landscape image is captured, when the real time position of the vehicle does not coincide with the position where the first landscape image is captured.

In some embodiments, prestoring the first landscape image of the first route captured at a first environmental visibility further comprises: prestoring landscape images of a plurality of second routes captured at the first environmental visibility. The method may further comprise: real timely positioning the vehicle to obtain a positioning result; and selecting the first landscape image from the prestored landscape images when the positioning result indicates that the vehicle runs on the first route.

In some embodiments, synthesizing the first landscape image and the second landscape image into the actual landscape image at the first environmental visibility and sending the actual landscape image to the vehicle display screen further comprises supplementing a brightness and colorfulness of the actual landscape image at the first environmental visibility.

In a fourth aspect, an image processing apparatus in communication with a vehicle display screen, where the image processing apparatus is configured to synthesize landscape images of a same route captured at different environmental visibilities, and where the image processing apparatus is further configured to instruct the vehicle display screen to display an actual landscape with a higher environmental visibility than a current environmental visibility when the vehicle runs on the same route.

In some embodiments, the image processing apparatus may further include an image library, configured to prestore a first landscape image of a first route captured at a first environmental visibility; a camera disposed at least partially outside of the vehicle, configured to real timely shoot a second landscape image of the first route at a second environmental visibility, where the first environmental visibility is higher than the second environmental visibility; a comparator, configured to compare the first landscape image and the second landscape image, so as to judge whether a real time position of the vehicle coincides with a position where the first landscape image is captured; an image synthesizer, configured to synthesize the first landscape image and the second landscape image into an actual landscape image at the first environmental visibility and to send the actual landscape image to the vehicle display screen when the comparator determines that the real time position of the vehicle coincides with the position where the first landscape image is captured.

In some embodiments, the image processing apparatus may further include: an adjusting circuitry configured to adjust the real time position of the vehicle to the position where the first landscape image is captured when the comparator determines that the real time position of the vehicle does not coincide with the position where the first landscape image is captured.

In some embodiments, the image library is further configured to prestore landscape images of a plurality of second routes captured at the first environmental visibility; the image processing apparatus further comprises a positioning circuitry configured to real timely position the vehicle and a selecting circuitry configured to select the first landscape image from the image library and send the first landscape image to the comparator when the positioning circuitry determines that the vehicle runs on the first route.

In some embodiments, each of the first landscape image and the second landscape image is a landscape picture sequence or a landscape video sequence.

In some embodiments, the image synthesizer is configured to supplement a brightness and colorfulness of the actual landscape image at the first environmental visibility.

In some embodiments, the image processing apparatus may be configured to compare landscape images of the same route captured at different environmental visibilities.

In some embodiments, the image processing apparatus is further configured to adjust landscape images of the same route captured at different environmental visibilities.

The following technical advantages are achieved by the display assembly according to embodiments of the present disclosure: with the image processing apparatus, the vehicle display screen of the display assembly can display the actual landscape with a higher environmental visibility than the current environmental visibility, such that a driver can more clearly understand the actual road conditions and traffic situations along the same route at the current low environmental visibility, thereby ensuring the vehicle to run safely at a low environmental visibility and improving the driving experience.

With the display assembly described hereinbefore, it is possible to improve the driving safety of the vehicle according to embodiments of the present disclosure at a low environmental visibility and also to improve the driving experience.

### BRIEF DESCRIPTION OF THE DRAWINGS

FIG. 1 is a schematic diagram of a display assembly according to embodiments of the present disclosure;

FIG. 2 is a flow diagram showing a displaying method of a display assembly according to embodiments of the present disclosure;

FIG. 3 is a schematic diagram of a display assembly according to other embodiments of the present disclosure;

FIG. 4 is a flow diagram showing a displaying method of a display assembly according to other embodiments of the present disclosure.

### DETAILED DESCRIPTION

In the following, a display assembly, a displaying method thereof, and a vehicle having the same according to embodiments of the present disclosure will be described in detail with reference to drawings, which are explanatory, illustrative, and used to generally understand the present disclosure.

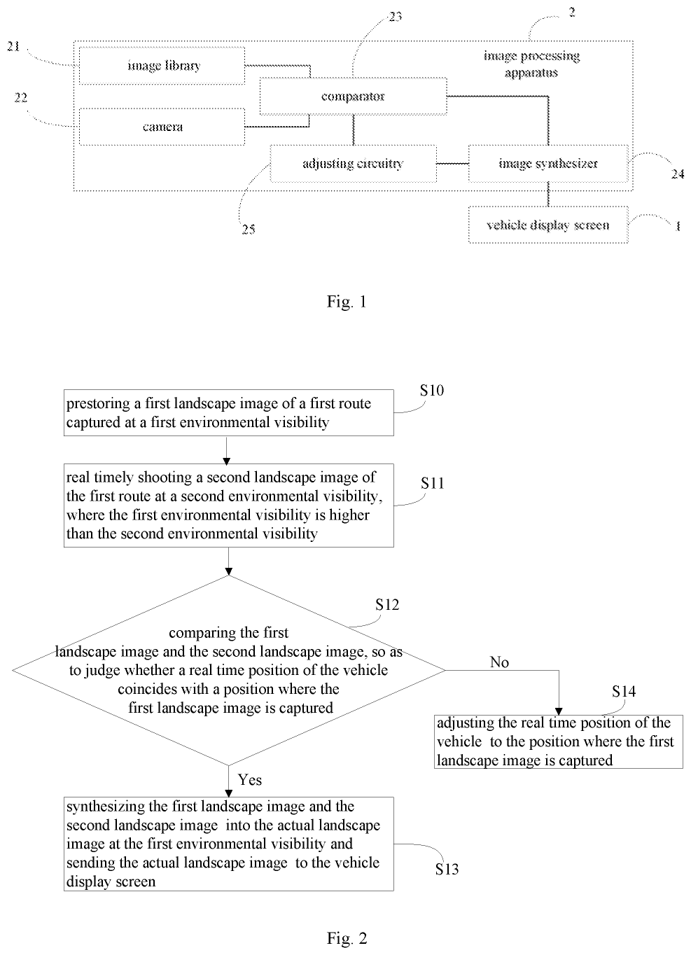

In some embodiments of the present disclosure, as shown in FIG. 1, a display assembly is provided. The display assembly includes a vehicle display screen 1 and an image processing apparatus 2. The image processing apparatus 2 is configured to compare, adjust, and synthesize landscape images of a same route captured at different environmental visibilities, so as to enable the vehicle display screen 1 to display an actual landscape with a higher environmental visibility than a current environmental visibility when the vehicle runs on the same route.

Term “different environmental visibilities” used herein may include, for example, an environmental visibility on fine weather such as during the daytime and an environmental visibility on bad weather such as at night or on a foggy day. Term “landscape image” refers to an image which indicates actual road conditions (such as defects on a pavement, exits and entrances upon lane change, turns, and traffic situations) and actual scenes (such as buildings) on both sides of the road along a route.

With the image processing apparatus 2, the vehicle display screen 1 may display the actual landscape with a higher environmental visibility than the current environmental visibility, such that a driver can more clearly understand the actual road conditions and traffic situations along the same route at the current low environmental visibility, thereby ensuring the vehicle to run safely at the low environmental visibility, avoiding accidents caused by road traps and avoiding a lane changing opportunity to be missed due to the low environmental visibility, and improving the driving experience.

In these embodiments, the image processing apparatus 2 includes an image library 21, a camera 22, a comparator 23 and an image synthesizer 24. The image library 21 is configured to prestore a first landscape image of a first route captured at a first environmental visibility. The first landscape image may include actual road conditions (including defects on a pavement, exits and entrances upon lane change, turns, etc., except traffic situations) and actual scenes (such as buildings) on both sides of the road along the first route at the first environmental visibility. The camera 22 is configured to real timely shoot a second landscape image of the first route at a second environmental visibility, where the first environmental visibility is higher than the second environmental visibility. The second landscape image may include actual road conditions (including defects on a pavement, exits and entrances upon lane change, turns, and traffic situations) and actual scenes (such as buildings) on both sides of the road along the first route at the second environmental visibility. The comparator 23 is configured to compare the first landscape image and the second landscape image, so as to judge whether a real time position of the vehicle coincides with a position where the first landscape image is captured. The image synthesizer 24 is configured to synthesize the first landscape image and the second landscape image into an actual landscape image at the first environmental visibility and to send the actual landscape image to the vehicle display screen 1 when the comparator 23 determines that the real time position of the vehicle coincides with the position where the first landscape image is captured.

When the first environmental visibility is higher than the second environmental visibility, the first landscape image and the second landscape image can be synthesized by the image synthesizer 24 into the actual landscape image with a higher environmental visibility (i.e. the first environmental visibility). The actual landscape image may include actual road conditions (including defects on a pavement, exits and entrances upon lane change, turns, and traffic situations) and actual scenes (such as buildings) on both sides of the road along the first route. The vehicle display screen 1 can receive and real timely display the actual landscape image, such that a driver can more clearly understand the actual road conditions and traffic situations along the same route at the current low environmental visibility, thereby ensuring the vehicle to run safely at a low environmental visibility, and improving the driving experience.

In these embodiments, the image processing apparatus 2 further includes an adjusting circuitry 25. The adjusting circuitry 25 is configured to adjust the real time position of the vehicle to the position where the first landscape image is captured when the comparator 23 determines that the real time position of the vehicle does not coincide with the position where the first landscape image is captured. The adjusting circuitry 25 enables the real time position of the vehicle to coincide real timely with the position where the first landscape image is captured, such that the image synthesizer 24 can real timely synthesize the first landscape image with the second landscape image when the real time position of the vehicle coincides with the position where the first landscape image is captured, so as to obtain the actual landscape image at the first environmental visibility which is more real and accurate, thereby ensuring the vehicle to run more safely at a low environmental visibility and improving the driving experience.

Alternatively, in these embodiments, each of the first landscape image and the second landscape image is a landscape picture sequence or a landscape video sequence. The image synthesizer 24 can synthesize a first landscape picture with a second landscape picture at a same position; or the image synthesizer 24 can synthesize a first landscape video clip with a second landscape video clip at the same position, so as to form the actual landscape image at the same position at the first environmental visibility.

In these embodiments, the image synthesizer 24 is configured to supplement a brightness and colorfulness of the actual landscape image at the first environmental visibility, so as to allow the actual landscape image at the first environmental visibility to be more clear and discernible, thereby ensuring the vehicle to run more safely at a low environmental visibility and improving the driving experience.

In these embodiments, the vehicle display screen 1 is a front windshield of the vehicle.

It should be noted that, the vehicle display screen 1 may also be disposed on the front windshield of the vehicle. Alternatively, the vehicle display screen 1 may be disposed on a partial or entire surface of the front windshield of the vehicle. Alternatively, the vehicle display screen 1 may also be a vehicle projection screen, and the vehicle projection screen is disposed on the front windshield of the vehicle or is the front windshield of the vehicle. Each vehicle display screen 1 described above enables the driver to conveniently and real timely view the actual landscape image at the first environmental visibility from the front windshield of the vehicle when driving.

Furthermore, it should be noted that, the vehicle display screen 1 may also be vehicle glasses or disposed on the vehicle glasses. When driving at the second environmental visibility, the driver can real timely view the actual landscape image at the first environmental visibility from the vehicle glasses as long as wearing the vehicle glasses.

Based on the display assembly described above, in these embodiments, a displaying method of the display assembly is provided. The displaying method includes:

step S1: comparing, adjusting and synthesizing landscape images of a same route captured at different environmental visibilities; and
step S2: displaying, by a vehicle display screen, an actual landscape image with a higher environmental visibility than the current environmental visibility, based on a previously obtained result.

Specifically, as shown in FIG. 2, the step S1 includes steps S10 to S15.

At step S10: a first landscape image of a first route captured at a first environmental visibility is prestored.

At step S11: a second landscape image of the first route at a second environmental visibility is real timely shot, where the first environmental visibility is higher than the second environmental visibility.

At step S12: the first landscape image and the second landscape image are compared, so as to judge whether a real time position of the vehicle coincides with a position where the first landscape image is captured.

At step S13: the first landscape image and the second landscape image are synthesized into the actual landscape image at the first environmental visibility and the actual landscape image is sent to the vehicle display screen, when the real time position of the vehicle coincides with the position where the first landscape image is captured.

At step S14: the real time position of the vehicle is adjusted to the position where the first landscape image is captured, when the real time position of the vehicle does not coincide with the position where the first landscape image is captured; and then step S13 is executed.

In addition, the step S13 further includes: supplementing a brightness and colorfulness of the actual landscape image at the first environmental visibility.

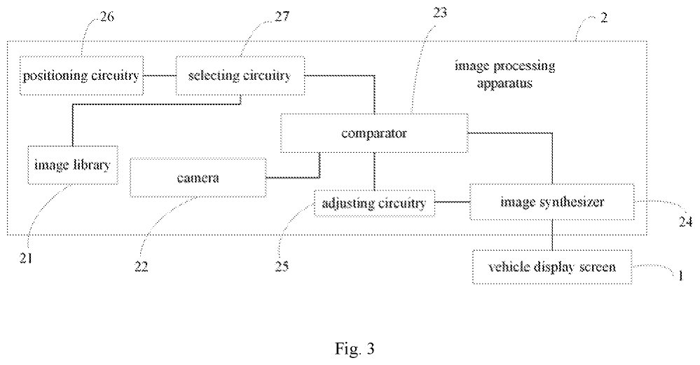

In other embodiments of the present disclosure, a display assembly is provided. The display assembly in these embodiments is substantially the same as that in the above embodiments shown in FIG. 1, except the followings. As shown in FIG. 3, the image library 21 is further configured to prestore landscape images of a plurality of second routes captured at the first environmental visibility. That is, the image library 21 prestores landscape images of a plurality of second routes captured at the first environmental visibility. The image processing apparatus 2 further includes a positioning circuitry 26 and a selecting circuitry 27. The positioning circuitry 26 is configured to real timely position the vehicle, so as to subsequently select from the image library 21 the first landscape image which is captured on a same route with the second landscape image, prior to synthesizing the first landscape image and the second landscape image, thereby ensuring that the first landscape image and the second landscape image on the same route are synthesized, and improving the accuracy and authenticity of the synthesized landscape image. The selecting circuitry 27 is configured to select the first landscape image from the image library 21 and send the first landscape image to the comparator 23 when the positioning circuitry 26 determines that the vehicle runs on the first route.

Alternatively, the positioning circuitry 26 is disposed at a central position of the vehicle. The location of the positioning circuitry 26 enables a travel route of the vehicle to be more accurately positioned. In some embodiments, a GPS positioning system is used as the positioning circuitry 26, and positions the travel route of the vehicle in combination with a navigation map therein.

Further, it should be noted that, the position of the vehicle on a route can also be positioned by the positioning circuitry 26, such that the adjusting circuitry 25 can real timely adjust the position of the vehicle based on the positioning circuitry 26 when the comparator 23 determines that the real time position of the vehicle does not coincide with the position where the first landscape image is captured. The location of the positioning circuitry 26 in the vehicle also enables the vehicle to be real timely and accurately positioned.

Other structural circuitry of the display assembly in these embodiments are the same as that described with respect to the above embodiments shown in FIG. 1, which will not be elaborated herein.

The positioning circuitry 26 and the selecting circuitry 27 can actually position the vehicle when running on different routes and select the corresponding landscape image of each route captured at the first environmental visibility from the image library 21, so as to enable the image synthesizer 24 to subsequently synthesize the real timely captured landscape image of the same route with the landscape image captured at the first environmental visibility, such that a driver can more clearly understand the actual road conditions and traffic situations along the same route at the current low environmental visibility, thereby ensuring the vehicle to run safely at a low environmental visibility and improving the driving experience.

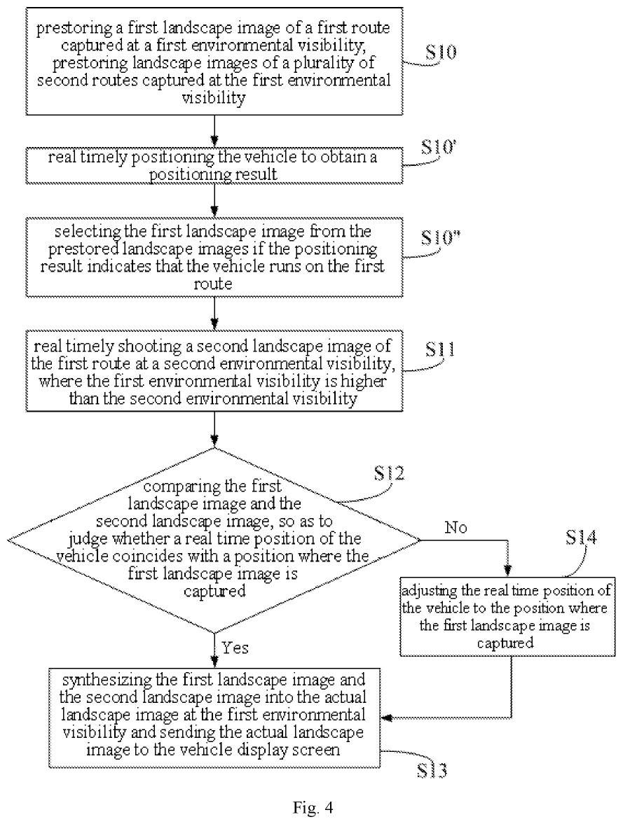

In embodiments of the present disclosure, a displaying method of the above mentioned display assembly is provided. The displaying method of the display assembly in these embodiments is substantially the same as that in the above embodiments shown in FIG. 2, except the followings. As shown in FIG. 4, in the displaying method, the step S10 further includes: prestoring landscape images of a plurality of second routes captured at the first environmental visibility.

The method, subsequent to the step S10 and prior to the step S11, further includes:

step S10′: real timely positioning the vehicle to obtain a positioning result; and
step S10″: selecting the first landscape image from the prestored landscape images when the positioning result indicates that the vehicle runs on the first route.

Other steps of the displaying method in these embodiments are the same as that described with respect to the above embodiments shown in FIG. 2, which will not be elaborated herein.

The following technical advantages can be achieved by the display assembly according to embodiments of the present disclosure: with the image processing apparatus, the vehicle display screen of the display assembly can display the actual landscape with a higher environmental visibility than the current environmental visibility, such that a driver can more clearly understand the actual road conditions and traffic situations along the same route at the current low environmental visibility, thereby ensuring the vehicle to run safely at a low environmental visibility and improving the driving experience.

In embodiments of the present disclosure, a vehicle including a display assembly described hereinbefore is provided.

With the display assembly described hereinbefore, it is possible to improve the driving safety of the vehicle at a low environmental visibility and also to improve the driving experience.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1. A display assembly, comprising:
a vehicle display screen disposed at least partially inside a vehicle; and
an image processing apparatus in communication with the vehicle display screen,
wherein the image processing apparatus is configured to synthesize landscape images of a same route captured at different environmental visibilities, and
wherein the image processing apparatus is further configured to instruct the vehicle display screen to display an actual landscape with a higher environmental visibility than a current environmental visibility when the vehicle runs on the same route.

2. The display assembly according to claim 1, wherein the image processing apparatus comprises:
an image library, configured to prestore a first landscape image of a first route captured at a first environmental visibility;
a camera disposed at least partially outside of the vehicle, configured to real timely shoot a second landscape image of the first route at a second environmental visibility, where the first environmental visibility is higher than the second environmental visibility;
a comparator, configured to compare the first landscape image and the second landscape image, so as to judge whether a real time position of the vehicle coincides with a position where the first landscape image is captured;
an image synthesizer, configured to synthesize the first landscape image and the second landscape image into an actual landscape image at the first environmental visibility and to send the actual landscape image to the vehicle display screen when the comparator determines that the real time position of the vehicle coincides with the position where the first landscape image is captured.

3. The display assembly according to claim 2, wherein the image processing apparatus further comprises an adjusting circuitry configured to adjust the real time position of the vehicle to the position where the first landscape image is captured when the comparator determines that the real time position of the vehicle does not coincide with the position where the first landscape image is captured.

4. The display assembly according to claim 2, wherein
the image library is further configured to prestore landscape images of a plurality of second routes captured at the first environmental visibility;
the image processing apparatus further comprises a positioning circuitry configured to real timely position the vehicle and a selecting circuitry configured to select the first landscape image from the image library and send the first landscape image to the comparator when the positioning circuitry determines that the vehicle runs on the first route.

5. The display assembly according to claim 2, wherein each of the first landscape image and the second landscape image is a landscape picture sequence or a landscape video sequence.

6. The display assembly according to claim 2, wherein the image synthesizer is configured to supplement a brightness and colorfulness of the actual landscape image at the first environmental visibility.

7. The display assembly according to claim 1, wherein the vehicle display screen is a front windshield of the vehicle; or
the vehicle display screen is disposed on a partial or entire surface of the front windshield of the vehicle; or
the vehicle display screen is a vehicle projection screen disposed on the front windshield of the vehicle or being the front windshield of the vehicle; or
the vehicle display screen is vehicle glasses or disposed on the vehicle glasses.

8. The display assembly according to claim 4, wherein the positioning circuitry is disposed at a central position of the vehicle.

9. A vehicle, comprising a display assembly according to claim 1.

10. A displaying method of a display assembly according to claim 1, comprising:
comparing, adjusting and synthesizing landscape images of a same route captured at different environmental visibilities;
displaying, by a vehicle display screen, an actual landscape image with a higher environmental visibility than the current environmental visibility, based on a previously obtained result.

11. The displaying method according to claim 10, wherein comparing, adjusting and synthesizing landscape images of the same route captured at different environmental visibilities comprises:
prestoring a first landscape image of a first route captured at a first environmental visibility;
real timely shooting a second landscape image of the first route at a second environmental visibility, where the first environmental visibility is higher than the second environmental visibility;
comparing the first landscape image and the second landscape image, so as to judge whether a real time position of the vehicle coincides with a position where the first landscape image is captured;
synthesizing the first landscape image and the second landscape image into the actual landscape image at the first environmental visibility and sending the actual landscape image to the vehicle display screen, when the real time position of the vehicle coincides with the position where the first landscape image is captured; and
adjusting the real time position of the vehicle to the position where the first landscape image is captured, when the real time position of the vehicle does not coincide with the position where the first landscape image is captured.

12. The displaying method according to claim 11, wherein prestoring the first landscape image of the first route captured at a first environmental visibility further comprises: prestoring landscape images of a plurality of second routes captured at the first environmental visibility; and
wherein the method further comprises:
real timely positioning the vehicle to obtain a positioning result; and
selecting the first landscape image from the prestored landscape images when the positioning result indicates that the vehicle runs on the first route.

13. The displaying method according to claim 11, wherein synthesizing the first landscape image and the second landscape image into the actual landscape image at the first environmental visibility and sending the actual landscape image to the vehicle display screen further comprises supplementing a brightness and colorfulness of the actual landscape image at the first environmental visibility.

14. An image processing apparatus in communication with a vehicle display screen,
wherein the image processing apparatus is configured to synthesize landscape images of a same route captured at different environmental visibilities, and
wherein the image processing apparatus is further configured to instruct the vehicle display screen to display an actual landscape with a higher environmental visibility than a current environmental visibility when the vehicle runs on the same route.

15. The image processing apparatus according to claim 14, further comprising:
an image library, configured to prestore a first landscape image of a first route captured at a first environmental visibility;
a camera disposed at least partially outside of the vehicle, configured to real timely shoot a second landscape image of the first route at a second environmental visibility, where the first environmental visibility is higher than the second environmental visibility;
a comparator, configured to compare the first landscape image and the second landscape image, so as to judge whether a real time position of the vehicle coincides with a position where the first landscape image is captured;
an image synthesizer, configured to synthesize the first landscape image and the second landscape image into an actual landscape image at the first environmental visibility and to send the actual landscape image to the vehicle display screen when the comparator determines that the real time position of the vehicle coincides with the position where the first landscape image is captured.

16. The image processing apparatus according to claim 15, further comprising:
an adjusting circuitry configured to adjust the real time position of the vehicle to the position where the first landscape image is captured when the comparator determines that the real time position of the vehicle does not coincide with the position where the first landscape image is captured.

17. The image processing apparatus according to claim 15, wherein
the image library is further configured to prestore landscape images of a plurality of second routes captured at the first environmental visibility;
the image processing apparatus further comprises a positioning circuitry configured to real timely position the vehicle and a selecting circuitry configured to select the first landscape image from the image library and send the first landscape image to the comparator when the positioning circuitry determines that the vehicle runs on the first route.

18. The image processing apparatus according to claim 15, wherein each of the first landscape image and the second landscape image is a landscape picture sequence or a landscape video sequence; and
wherein the image synthesizer is configured to supplement a brightness and colorfulness of the actual landscape image at the first environmental visibility.

19. The image processing apparatus according to claim 15, further configured to compare landscape images of the same route captured at different environmental visibilities.

20. The image processing apparatus according to claim 15, further configured to adjust landscape images of the same route captured at different environmental visibilities.
